(19) United States
(12) Patent Application Publication
(10) Pub. No.: US 2025/0383562 A1
(43) Pub. Date: Dec. 18, 2025

(54) LIQUID CRYSTAL DISPLAY DEVICE

(71) Applicant: Sharp Display Technology Corporation, Kameyama City (JP)

(72) Inventors: Yuichi KAWAHIRA, Kameyama City (JP); Masahiro HASEGAWA, Kameyama City (JP); Ryosuke SAIGUSA, Kameyama City (JP); Jianeng XU, Kameyama City (JP); Akira SAKAI, Kameyama City (JP)

(21) Appl. No.: 19/235,572

(22) Filed: Jun. 12, 2025

(30) Foreign Application Priority Data
Jun. 14, 2024 (JP) 2024-096538

(51) Int. Cl. G02F 1/1335; G02F 1/13363

(52) U.S. Cl. CPC G02F 1/133528; G02F 1/13363; G02F 2413/02; G02F 2413/05

(57) ABSTRACT

Provided is a liquid crystal display device in which light leakage during black display is reduced or prevented. The liquid crystal display device includes, in order, a backlight, a first polarizer, a first substrate which exhibits birefringence in a direction parallel to a direction of stress, a liquid crystal layer, a second substrate which exhibits birefringence in a direction parallel to a direction of stress, and a second polarizer. The liquid crystal display device includes, on at least one of a first polarizer side relative to the first substrate or a second polarizer side relative to the second substrate, at least one laminate of a bonding layer with a storage modulus at 25° C. of 0.10 MPa or more and a film that exhibits birefringence in a direction vertical to a direction of stress.

### CROSS-REFERENCE TO RELATED APPLICATIONS

The present application claims priority under 35 U.S.C. § 119 to Japanese Patent Application No. 2024-096538 filed on Jun. 14, 2024, the contents of which are incorporated herein by reference in their entirety.

### BACKGROUND OF THE INVENTION

### Field of the Invention

The disclosure relates to liquid crystal display devices.

### Description of Related Art

A transparent plastic or glass, when distorted by external force, exhibits birefringence as a result of the distortion. This phenomenon is called “photoelasticity”. In the fields of display devices and optical films, material selection is sometimes carried out with consideration of photoelasticity.

JP 5414960 B discloses a liquid crystal display device in which a phase difference (retardation) may be removed from a glass substrate when stress is applied to a display screen, thereby minimizing light leakage from the display screen. In the liquid crystal display device, positive photoelasticity of the glass substrate is compensated with negative photoelasticity of a compensation film to remove retardation exerted when stress is applied to the glass substrate.

JP 4338759 B discloses an optical film made of a resin composition of a thermoplastic resin (A) with a negative photoelastic coefficient and a low molecular compound (B) with a photoelastic coefficient more likely to increase than the photoelastic coefficient of the thermoplastic resin (A) to provide an optical film having high birefringence and showing a small change in birefringence under an external pressure, i.e., a small absolute value of a photoelastic coefficient.

JP 2009-42673 A discloses a phase difference film with a photoelastic coefficient of 2×10⁻¹¹ Pa⁻¹ or less.

### BRIEF SUMMARY OF THE INVENTION

In a flat-shaped liquid crystal display device, a polarizer attached to a liquid crystal panel causes the panel to warp. When the warped panel is forcibly flattened by attaching a cover glass to the panel or incorporating the panel into a bezel (enclosure), stress is applied partially to the glass substrate constituting the liquid crystal panel, causing light leakage during black display (black unevenness). FIG. 1 illustrates the principle by which light leakage during black display occurs in a flat-shaped liquid crystal display device. As shown in the figure, a liquid crystal panel 310 before polarizer bonding does not suffer from warping. However, a liquid crystal panel 320 after polarizer bonding may suffer from warping. Although the warping can be forcibly eliminated by attaching a cover glass 350 to the liquid crystal panel 320 after polarizer bonding, a liquid crystal panel 380 after cover glass bonding, which is a laminate of a forcibly flattened liquid crystal panel 330 and the cover glass 350, will cause light leakage during black display. FIG. 2 shows a photograph of black display (top) of the liquid crystal panel 310 before polarizer bonding and a photograph of black display (bottom) of the liquid crystal panel 380 after cover glass bonding, for comparison.

In a liquid crystal display device deformable into a curved shape, the glass substrate is forcibly warped into the intended curved shape irrespective of the process above, so that stress is applied to portions of the glass substrate to cause light leakage (unevenness) during black display.

In response to the issues above, the present invention aims to provide a liquid crystal display device in which light leakage during black display is reduced or prevented.
(1) One embodiment of the present invention is directed to a liquid crystal display device including, in order: a backlight; a first polarizer; a first substrate which exhibits birefringence in a direction parallel to a direction of stress; a liquid crystal layer; a second substrate which exhibits birefringence in a direction parallel to a direction of stress; and a second polarizer, the liquid crystal display device comprising, on at least one of a first polarizer side relative to the first substrate or a second polarizer side relative to the second substrate, at least one laminate of a bonding layer with a storage modulus at 25° C. of 0.10 MPa or more and a film that exhibits birefringence in a direction vertical to a direction of stress.
(2) In an embodiment of the present invention, the liquid crystal display device includes the structure (1), and the at least one laminate, on at least one of the first polarizer side relative to the first substrate or the second polarizer side relative to the second substrate, includes a plurality of laminates.
(3) In an embodiment of the present invention, the liquid crystal display device includes the structure (1) or (2), and the at least one laminate is on both the first polarizer side relative to the first substrate and the second polarizer side relative to the second substrate.
(4) In an embodiment of the present invention, the liquid crystal display device includes the structure (1) or (2), and the at least one laminate is only on the first polarizer side relative to the first substrate.
(5) In an embodiment of the present invention, the liquid crystal display device includes the structure (1) or (2), and the at least one laminate is only on the second polarizer side relative to the second substrate.
(6) In an embodiment of the present invention, the liquid crystal display device includes the structure (1), (2), (3), (4) or (5), and a sum of absolute values of products of a photoelastic constant and thickness of the film in the at least one laminate is approximately equal to an absolute value of a product of a photoelastic constant and thickness of the first substrate or the second substrate, whichever is adjacent to the at least one laminate.
(7) In an embodiment of the present invention, the liquid crystal display device includes the structure (1), (2), (3), (4), (5) or (6), and the film includes a polymethyl methacrylate resin.

The present invention can provide a liquid crystal display device in which light leakage during black display can be reduced or prevented.
(8) In an embodiment of the present invention, the liquid crystal display device includes the structure (1), (2), (3), (4), (6) or (7), and the number of the at least one laminate on the first polarizer side relative to the first substrate is 4 or more.
(9) In an embodiment of the present invention, the liquid crystal display device includes the structure (1), (2), (3), (4), (6), (7) or (8), and the number of the at least one laminate on the first polarizer side relative to the first substrate is larger than the number of the at least one laminate on the second polarizer side relative to the second substrate.

### BRIEF DESCRIPTION OF THE DRAWINGS

FIG. 1 illustrates the principle by which light leakage occurs during black display in a flat-shaped liquid crystal display device.

FIG. 2 shows a photograph of black display (top) of the liquid crystal panel 310 before polarizer bonding and a photograph of black display (bottom) of the liquid crystal panel 380 after cover glass bonding, for comparison.

FIG. 3 is a cross-sectional view schematically showing the structure of a polarizer-including liquid crystal panel in a conventional liquid crystal display device.

FIG. 4 shows the birefringence exhibited when stress is applied to the polarizer-including liquid crystal panel shown in FIG. 3.

FIG. 5 is a cross-sectional view schematically showing the structure of a polarizer-including liquid crystal panel in a liquid crystal display device of an embodiment.

FIG. 6 shows the birefringences exhibited when stress is applied to the polarizer-including liquid crystal panel shown in FIG. 5.

FIG. 7 is a perspective view schematically showing a method of measuring the photoelastic coefficient.

FIG. 8 is a graph showing the relationship between stress and the exhibited phase difference.

FIG. 9 is a cross-sectional view schematically showing the structure of a polarizer-including liquid crystal panel in a liquid crystal display device of Example 1.

FIG. 10 is a cross-sectional view schematically showing the structure of a polarizer-including liquid crystal panel in a liquid crystal display device of Example 2.

FIG. 11 is a cross-sectional view schematically showing the structure of a polarizer-including liquid crystal panel in a liquid crystal display device of Example 3.

FIG. 12 is a cross-sectional view schematically showing the structure of a polarizer-including liquid crystal panel in a liquid crystal display device of Example 4.

FIG. 13 is a cross-sectional view schematically showing the structure of a polarizer-including liquid crystal panel in a liquid crystal display device of Example 5.

FIG. 14 is a cross-sectional view schematically showing the structure of a polarizer-including liquid crystal panel in a liquid crystal display device of Example 6.

FIG. 15 is a cross-sectional view schematically showing the structure of a polarizer-including liquid crystal panel in a liquid crystal display device of Comparative Example 1.

FIG. 16 is a cross-sectional view schematically showing the structure of a polarizer-including liquid crystal panel in a liquid crystal display device of Comparative Example 2.

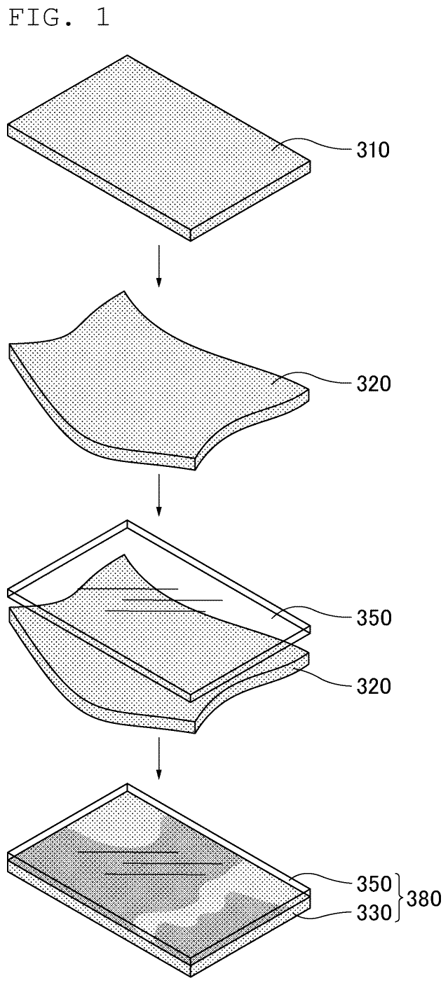

### DETAILED DESCRIPTION OF THE INVENTION

Hereinafter, an embodiment of the present invention is described. The present invention is not limited to the contents of the following embodiment. The design may be modified as appropriate within the range satisfying the configuration of the present invention. In the following description, components having the same or similar functions in different drawings are commonly provided with the same reference sign so as to appropriately avoid repetition of description. The structures in the present invention may be combined as appropriate without departing from the gist of the present invention.

A liquid crystal display device of the present embodiment includes, in order, a backlight, a first polarizer, a first substrate which exhibits birefringence in a direction parallel to a direction of stress, a liquid crystal layer, a second substrate which exhibits birefringence in a direction parallel to a direction of stress, and a second polarizer. The liquid crystal display device includes, on at least one of a first polarizer side relative to the first substrate or a second polarizer side relative to the second substrate, at least one laminate of a bonding layer with a storage modulus at 25° C. of 0.10 MPa or more and a film that exhibits birefringence in a direction vertical to a direction of stress.

Herein, “exhibiting the birefringence in a direction parallel to the direction of stress” is also expressed as “having positive photoelasticity (photoelastic coefficient)”, and “exhibiting the birefringence in a direction vertical to the direction of stress” is also expressed as “having negative photoelasticity (photoelastic coefficient)”. The stress may be applied temporarily to the liquid crystal display device or may be applied constantly to the liquid crystal display device. Examples of the stress applied temporarily to the liquid crystal display device include stress applied upon operation of the touch panel. Examples of the stress applied constantly to the liquid crystal display device include stress applied upon deforming the liquid crystal panel into a given shape (which may be a planar shape) through, for example, bonding of a cover glass to the observer side of the liquid crystal panel or incorporation of the liquid crystal panel into the bezel (enclosure).

The material of the first substrate and the second substrate may be any material that exhibits birefringence (has positive photoelasticity) in a direction parallel to the direction of stress. Examples include glass, cycloolefin polymers, and polycarbonate. Glass is a substance that exhibits birefringence (has positive photoelasticity) in a direction parallel to the direction of stress.

The material of the bonding layer may be any material with a storage modulus at 25° C. of 0.10 MPa or more. Examples include acrylic adhesives. Herein, the “bonding layer” may be an adhesive layer with pressure-sensitive adhesiveness, or may be a structural adhesive layer formable by curing a liquid structural adhesive. The storage modulus may be adjusted by, for example, adjusting the type and/or composition, e.g., amount, of the resin to be added to the bonding layer or adjusting the curing temperature and/or curing time for production of the bonding layer.

The material of the film may be any material that exhibits birefringence (has negative photoelasticity) in a direction vertical to the direction of stress. Examples include acrylic resins. Suitable acrylic resins include polymethyl methacrylate resin.

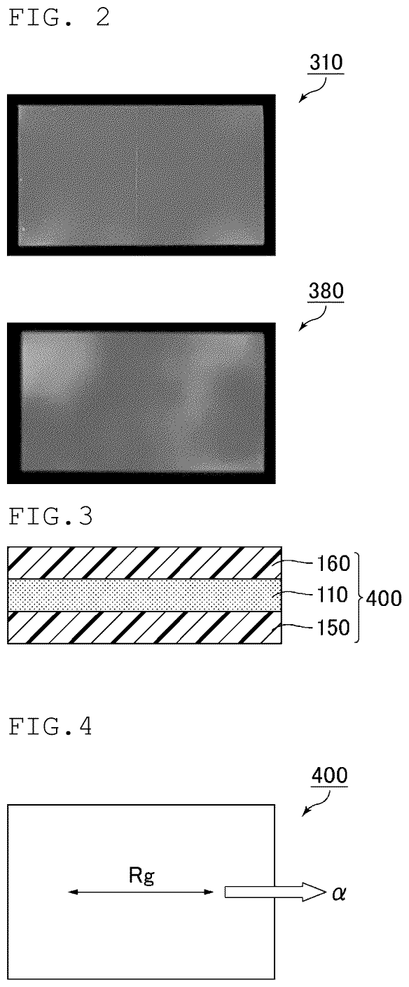

FIG. 3 is a cross-sectional view schematically showing the structure of a polarizer-including liquid crystal panel in a conventional liquid crystal display device. FIG. 4 shows the birefringence exhibited when stress is applied to the polarizer-including liquid crystal panel shown in FIG. 3. As shown in FIG. 3, a polarizer-including liquid crystal panel 400 in a conventional liquid crystal display device includes, in order from a backlight (omitted from the figure) side, a first polarizer 150, a liquid crystal panel 110, and a second polarizer 160. The liquid crystal panel 110 includes a TFT substrate, a liquid crystal layer, and a color filter substrate. The TFT substrate and the color filter substrate each include a glass substrate. Thus, as shown in FIG. 4, when stress α is applied to the polarizer-including liquid crystal panel 400, birefringence is exhibited in a direction parallel to the direction of stress α. As a result, a glass photoelastic phase difference Rg represented by the following equation is generated.

$$Rg = {β}_{g} \times α \times {d}_{g}$$

β_{g}: photoelastic coefficient of glass
α: magnitude of stress
d_{g}: thickness of glass

The polarizer-including liquid crystal panel has a structure in which a liquid crystal panel is sandwiched between two polarizers with perpendicular absorption axes (crossed Nicols polarizers). Thus, when stress is applied to the liquid crystal panel 110, the birefringence (phase difference) is exhibited in the glass substrate in the liquid crystal panel 110. This phase difference causes light leakage in crossed Nicols polarizers, and light leakage may be observed as black display unevenness.

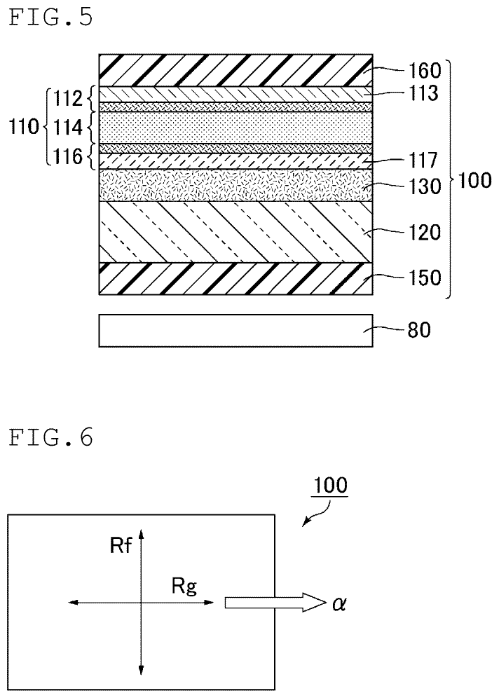

FIG. 5 is a cross-sectional view schematically showing the structure of a polarizer-including liquid crystal panel in a liquid crystal display device of an embodiment. FIG. 6 shows the birefringences exhibited when stress is applied to the polarizer-including liquid crystal panel shown in FIG. 5. As shown in FIG. 5, a polarizer-including liquid crystal panel 100 in the liquid crystal display device of the embodiment includes, in order from a backlight 80 side toward the observer side, the first polarizer 150, a negative photoelastic film 120, a high-modulus bonding layer 130, the liquid crystal panel 110, and the second polarizer 160. The liquid crystal panel 110 includes a TFT substrate 116, a liquid crystal layer 114, and a color filter substrate 112. The TFT substrate 116 is the backlight 80 side substrate and includes a first glass substrate 117 as the first substrate. The color filter substrate 112 is the observer side substrate and includes a second glass substrate 113 as the second substrate. The first glass substrate 117 and the second glass substrate 113 each exhibit birefringence in a direction parallel to the direction of stress. Thus, as shown in FIG. 6, when stress α is applied to the polarizer-including liquid crystal panel 100, the liquid crystal panel 110 exhibits birefringence in the direction parallel to the direction of stress α, thus providing a glass photoelastic phase difference Rg.

The negative photoelastic film 120 exhibits birefringence in a direction vertical to the direction of stress. As shown in FIG. 6, when the stress α is applied to the polarizer-including liquid crystal panel 100, the negative photoelastic film 120 exhibits birefringence in a direction vertical to the direction of stress α. As a result, a film photoelastic phase difference Rf represented by the following equation is provided.

$$Rf = {β}_{f} \times α \times {d}_{f}$$

β_{f}: photoelastic coefficient of film
α: magnitude of stress
d_{f}: thickness of film

The high-modulus bonding layer 130 has a storage modulus at 25° C. of 0.10 MPa or more. With the high-modulus bonding layer 130 used to bond the negative photoelastic film 120 to the liquid crystal panel 110, upon application of stress of a certain magnitude in a certain direction, as shown in FIG. 6, the exhibited birefringences can be offset between the glass substrate (first glass substrate 117) and the negative photoelastic film 120. This reduces light leakage (unevenness) during black display.

If a bonding layer with a storage modulus less than 0.10 MPa was used to bond the negative photoelastic film 120, stress would be reduced by the bonding layer, so that the stress applied to the glass substrate (first glass substrate 117) and the stress applied to the negative photoelastic film 120 could not be equalized. This means that the glass photoelastic phase difference Rg and the film photoelastic phase difference Rf would not offset each other. Thus, in the present embodiment, a bonding layer with a storage modulus at 25° C. of 0.10 MPa or more is used.

The storage modulus can be measured using a rotational rheometer, for example, in conformity with JIS K 7244-10 (Plastics—Determination of dynamic mechanical properties—Part 10: Complex shear viscosity using a parallel-plate oscillatory rheometer).

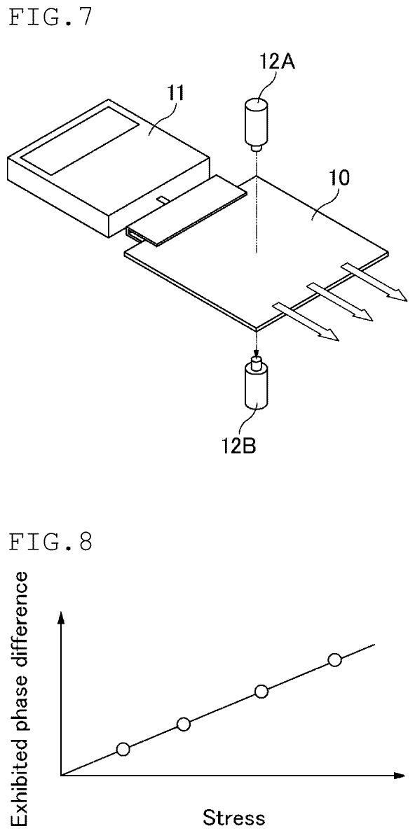

The photoelastic coefficient can be measured by the following method. FIG. 7 is a perspective view schematically showing a method of measuring the photoelastic coefficient. FIG. 8 is a graph showing the relationship between stress and the exhibited phase difference.

As shown in FIG. 7, a force gauge 11 is attached to one side of a measurement sample 10. Specific examples of the force gauge 11 include a digital force gauge “FGC-2B” available from Nidec Drive Technology Corporation. The end of the measurement sample 10 opposite to the end with the force gauge 11 is pulled with a jig or by hand. The stress σ applied to the measurement sample 10 during the pulling is calculated as σ=(magnitude of force F displayed on force gauge 11)÷(width w of measurement sample 10 in direction perpendicular to pulling direction)÷(thickness t of measurement sample 10) [Pa]. Also, the in-plane phase difference [nm] exhibited in the measurement sample 10 is measured with a birefringence measurement device. Specific examples of the birefringence measurement device include “Axoscan” available from Axometrics, Inc. The in-plane phase difference [nm] exhibited in the measurement sample 10 is measured by irradiating the measurement sample 10 with light from a light emitter 12A, receiving the light transmitted through the measurement sample 10 by a light detector 12B. While the magnitude of force of pulling the measurement sample 10 is varied, the phase difference exhibited in the measurement sample 10 during the pulling is measured at multiple points, so that a graph as shown in FIG. 8 can be obtained. The following relationship holds: phase difference δ [mm]=photoelastic coefficient β[10⁻¹² Pa]×stress σ [Pa]×thickness t [cm]. Thus, the photoelastic coefficient can be calculated from the graph slope. The unit for a photoelastic coefficient may be “cm²/dyn” based on the relationship 1 Pa=1 dyn/cm².

The following shows example photoelastic coefficients measured by the measurement method above.
Glass plate: +3.60E-13 (cm²/dyn)
Acrylic film: −2.70E-13 (cm²/dyn)

Herein, “E-x (wherein x represents any number)” represents “E×10^{-x}”.

FIG. 5 shows an embodiment in which a laminate of one negative photoelastic film 120 and one high-modulus bonding layer 130 is provided on a backlight side (first polarizer 150 side relative to the first glass substrate 117) of the liquid crystal panel 110. In the present embodiment, the laminate needs to be provided on at least one of the first polarizer 150 side relative to the first glass substrate 117 or the second polarizer 160 side relative to the second glass substrate 113. In other words, the position of the laminate may be any one of the following embodiments (1) to (3).
(1) Embodiment in which the laminate is provided on each of the first polarizer 150 side relative to the first glass substrate 117 and the second polarizer 160 side relative to the second glass substrate 113
(2) Embodiment in which the laminate is provided only on the first polarizer 150 side relative to the first glass substrate 117 and not on the second polarizer 160 side relative to the second glass substrate 113
(3) Embodiment in which the laminate is provided only on the second polarizer 160 side relative to the second glass substrate 113 and not on the first polarizer 150 side relative to the first glass substrate 117

To prevent intensification of polarization disorder due to passage through the liquid crystal layer, the embodiments (1) and (2) are preferred.

Any number of the laminates may be stacked. A plurality of the laminates may be provided on at least one of the first polarizer 150 side relative to the first glass substrate 117 or the second polarizer 160 side relative to the second glass substrate 113. The number of the at least one laminate on the first polarizer 150 side relative to the first glass substrate 117 may be equal to or larger than the number of the at least one laminate on the second polarizer 160 side relative to the second glass substrate 113. In the present embodiment, preferably, the sum of the absolute values of the products of the photoelastic constant and thickness of the negative photoelastic film 120 in the at least one laminate is approximately equal to the absolute value of the product of the photoelastic constant and thickness of the first glass substrate 117 or the second glass substrate 113, whichever is adjacent to the at least one laminate. For example, preferably, the sum of the absolute values of the products of the photoelastic constant and thickness of the negative photoelastic film 120 in the laminate(s) is 0.9 times or more and 1.1 times or less of the absolute value of the product of the photoelastic constant and thickness of the first glass substrate 117 or the second glass substrate 113, whichever is adjacent to the at least one laminate. In the case where N (where N is any integer) negative photoelastic films 120 are included in the at least one laminate, the absolute value of the product of the photoelastic constant and thickness of each of the N negative photoelastic films 120 is determined, and the determined absolute values are added up. The addition result serves as the sum of the absolute values of the products of the photoelastic constant and thickness of the negative photoelastic film 120 in the at least one laminate.

The laminate on the first polarizer 150 side relative to the first glass substrate 117 preferably satisfies the following Equation (1). The following Equation (1) shows the case where the negative photoelastic films 120 on the first polarizer 150 side relative to the first glass substrate 117 have the same photoelastic coefficient and are of the same thickness.

$$\vert {β}_{g 1} \times {d}_{g 1} \vert = \vert {β}_{f 1} \times {d}_{f 1} \vert \times {N}_{f 1} \qquad ( 1 )$$

β_{g1}: photoelastic coefficient of first glass substrate 117
d_{g1}: thickness of first glass substrate 117
β_{f1}: photoelastic coefficient of negative photoelastic film 120 on first polarizer 150 side relative to first glass substrate 117
d_{f1}: thickness of negative photoelastic film 120 on first polarizer 150 side relative to first glass substrate 117
N_{f1}: the number of negative photoelastic films 120 on first polarizer 150 side relative to first glass substrate 117

The laminate on the second polarizer 160 side relative to the second glass substrate 113 preferably satisfies the following Equation (2). The following Equation (2) corresponds to the case where the negative photoelastic films 120 on the second polarizer 160 side relative to the second glass substrate 113 have the same photoelastic coefficient and are of the same thickness.

$$\vert {β}_{g 2} \times {d}_{g 2} \vert = \vert {β}_{f 2} \times {d}_{f 2} \vert \times {N}_{f 2} \qquad ( 2 )$$

β_{g2}: photoelastic coefficient of second glass substrate 113
d_{g2}: thickness of second glass substrate 113
β_{f2}: photoelastic coefficient of negative photoelastic film 120 on second polarizer 160 side relative to second glass substrate 113
d_{f2}: thickness of negative photoelastic film 120 on second polarizer 160 side relative to second glass substrate 113
N_{f2}: the number of negative photoelastic films 120 on second polarizer 160 side relative to second glass substrate 113

### EXAMPLES

### Examples and Comparative Examples

Hereinbelow, the effect of the present invention is described based on examples and comparative examples. The present invention is not limited to these examples.

### Comparative Example 1

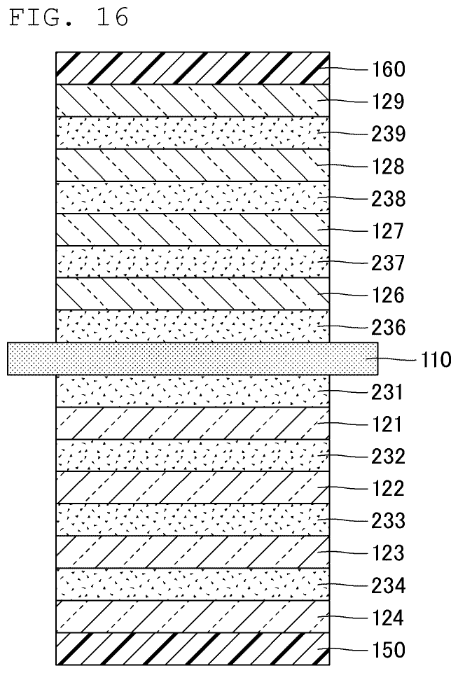

FIG. 15 is a cross-sectional view schematically showing the structure of a polarizer-including liquid crystal panel in a liquid crystal display device of Comparative Example 1. As shown in the figure, the liquid crystal display device of Comparative Example 1 included, in order from the backlight (omitted from the figure) side, the first polarizer 150, an adhesive layer 231, the liquid crystal panel 110, an adhesive layer 236, and the second polarizer 160. The first polarizer 150, the adhesive layer 231, the liquid crystal panel 110, the adhesive layer 236, and the second polarizer 160 were laminated and integrated. Herein, a laminate including the adhesive layers 231 and 236, the liquid crystal panel 110, and the like between the first polarizer 150 and the second polarizer 160 is referred to as “polarizer-including liquid crystal panel”.

The liquid crystal panel 110 of Comparative Example 1 had a 11.4-inch (259 mm×151 mm) screen and was in the fringe field switching (FFS) display mode. The liquid crystal panel 110 had the structure shown in FIG. 5 and included a TFT substrate, a liquid crystal layer, and a color filter substrate. The liquid crystal layer contained a positive liquid crystal. The TFT substrate was the backlight side substrate and included a first glass substrate as the first substrate. The color filter substrate was the observer side substrate and included a second glass substrate as the second substrate. Hereinbelow, in the case of describing matter common to the first glass substrate and the second glass substrate, these substrates are also simply referred to as “glass substrate”.

The first polarizer (backlight side polarizer) 150 was a laminate including a protective layer (triacetyl cellulose (TAC))/a polarizing layer (polyvinyl alcohol (PVA))/a protective layer (triacetyl cellulose (TAC)) from the backlight side, and had a total thickness of 65 μm. The second polarizer (observer side polarizer) 160 was a laminate including a viewing angle compensation layer (cycloolefin polymer (COP))/a polarizing layer (polyvinyl alcohol (PVA))/a protective layer (triacetyl cellulose (TAC)) from the liquid crystal panel side, and had a total thickness of 80 μm. Each of the adhesive layers 231 and 236 was made of an acrylic adhesive, had a thickness of 20 μm, and had a storage modulus at 25° C. of 0.04 MPa.

The photoelastic coefficient β_{g}, the thickness do, and the product of the photoelastic coefficient β_{g} and the thickness d_{g} of the glass substrate were as described below. The following values represent the values of each of the glass substrate in the color filter substrate and the glass substrate in the TFT substrate.
Photoelastic coefficient β_{g}: +3.60E-13 (cm²/dyn)
Thickness d_{g}: 150 μm (=0.15 mm)

$${β}_{g} \times {d}_{g} : + 5.4 E - 15 ( {cm}^{3} / dyn )$$

### (Method of Assessing Black Display Unevenness)

The polarizer-including liquid crystal panel was bonded to a planar cover glass with a thickness of 1.7 mm. Herein, a laminate in which a cover glass is bonded to the polarizer-including liquid crystal panel is referred to as “cover glass-including liquid crystal panel”. Although slight warping due to shrinkage of the polarizer was observed in the polarizer-including liquid crystal panel of Comparative Example 1 in the state shown in FIG. 15, this slightly warped polarizer-including liquid crystal panel, when bonded to the cover glass, forcibly achieved a state free of warping.

The obtained cover glass-including liquid crystal panel was placed on a backlight, and the in-plane luminance distribution of the panel during black display was measured using a 2D color analyzer (CA-2000 available from KONICA MINOLTA, INC.). From the measured results, the black display unevenness index value was obtained by dividing the panel in-plane minimum luminance by the panel in-plane maximum luminance as shown in the following equation.

(Black display unevenness index value)=(panel in-plane minimum luminance in black display state)÷(panel in-plane maximum luminance in black display state)×100[%]

The smaller the panel in-plane luminance variation in the black display state is, i.e., the smaller the unevenness is, the closer the panel in-plane maximum luminance and the panel in-plane minimum luminance are, and the closer to 100% the index value is. In other words, the greater the index value is, the smaller the unevenness of the polarizer-including liquid crystal panel can be determined. According to the results of a subjective visual evaluation of black display unevenness of polarizer-including liquid crystal panels with a variety of black display unevenness index values, when the index value exceeds 30%, the unevenness is less perceivable.

### (Results of Black Display Unevenness Assessment)

The in-plane luminance distribution of the cover glass-including liquid crystal panel of Comparative Example 1 in the black display state was measured, and the maximum luminance and the minimum luminance were extracted, which were as shown below. The black display unevenness index value was 23%, and unevenness was clearly perceived.
Panel in-plane maximum luminance: 2.730 (cd/m²)
Panel in-plane minimum luminance: 0.630 (cd/m²)
Black display unevenness index value: 23%

### Comparative Example 2

FIG. 16 is a cross-sectional view schematically showing the structure of a polarizer-including liquid crystal panel in a liquid crystal display device of Comparative Example 2. As shown in the figure, the liquid crystal display device of Comparative Example 2 included, in order from the backlight (omitted from the figure) side, the first polarizer 150, an acrylic film 124, an adhesive layer 234, an acrylic film 123, an adhesive layer 233, an acrylic film 122, an adhesive layer 232, an acrylic film 121, the adhesive layer 231, the liquid crystal panel 110, the adhesive layer 236, an acrylic film 126, an adhesive layer 237, an acrylic film 127, an adhesive layer 238, an acrylic film 128, an adhesive layer 239, an acrylic film 129, and the second polarizer 160. These layers and films were laminated and integrated.

In Comparative Example 2, the first polarizer 150, the liquid crystal panel 110, and the second polarizer 160 were the same as those described in Comparative Example 1. Four acrylic films were bonded to the observer side of the liquid crystal panel 110 and four to the backlight side, each via an adhesive layer. The acrylic films 121 to 124 and 126 to 129 were made of a polymethyl methacrylate resin (PMMA). The adhesive layers 231 to 234 and 236 to 239 were made of an acrylic adhesive and had a storage modulus at 25° C. of 0.04 MPa.

The acrylic films 121 to 124 and 126 to 129 had a negative photoelastic coefficient. The photoelastic coefficient β_{f}, the thickness d_{f}, and the number of films N_{f} on each of the observer side and the backlight side of the liquid crystal panel 110, and the product of the photoelastic coefficient β_{f}, the thickness d_{f}, and the number of films N_{f} were as shown below. The following value of β_{f}×d_{f}×NE represents the value of each of the total value on the observer side of the liquid crystal panel 110 and the total value on the backlight side of the liquid crystal panel 110.
Photoelastic coefficient β_{f}: −2.70E-13 (cm²/dyn)
Thickness d_{f}: 50 μm
Number of films N_{f}: 4

$${β}_{f} \times {d}_{f} \times {N}_{f} : - 5.4 E - 15 ( {cm}^{3} / dyn )$$

### (Results of Black Display Unevenness Assessment)

The same assessment method as in Comparative Example 1 was used to measure the in-plane luminance distribution of the cover glass-including liquid crystal panel of Comparative Example 2 in the black display state, and the maximum luminance and the minimum luminance were extracted, which were as shown below.

The black display unevenness index value was 28%, which was slightly better than the value in Comparative Example 1 but did not reach 30%, the target for improvement. Unevenness was still clearly perceived.
Panel in-plane maximum luminance: 2.170 (cd/m²)
Panel in-plane minimum luminance: 0.601 (cd/m²)
Black display unevenness index value: 28%

The number of laminated acrylic films in Comparative Example 2 was set to 4 to make the product β_{f}×d_{f}×N_{f} of the film photoelastic coefficient β_{f}, the film thickness d_{f}, and the number of films N_{f} equal to the product β_{g}×d_{g} of the photoelastic coefficient β_{g} and the thickness d_{g} of the glass substrate. In this structure, upon application of stress, in principle, the phase difference induced by the photoelasticity of the glass substrate should be offset by the phase difference of the same magnitude generated perpendicularly thereto in the acrylic films with the negative photoelastic coefficient. The results, however, indicated that such offsetting did not actually occur. In the structure of Comparative Example 2, the stress applied to the polarizer-including liquid crystal panel upon the bonding to the cover glass was not transmitted through the adhesive layers which had a small storage modulus. As a result, stress of the same magnitude as that applied to the liquid crystal panel (glass substrate) was not applied to the acrylic films, so that the black display unevenness was not reduced.

### Example 1

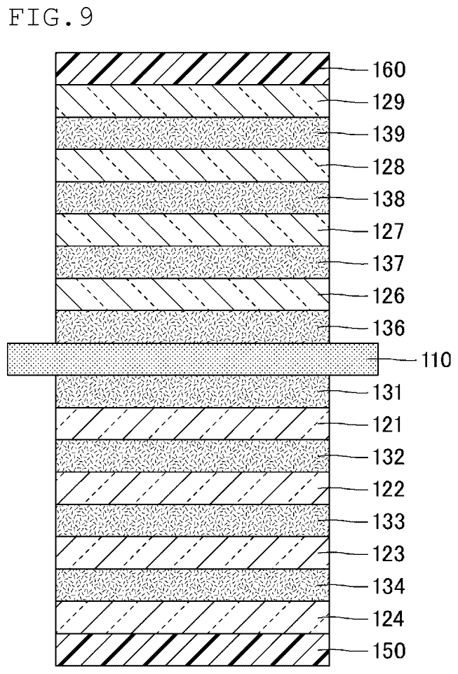

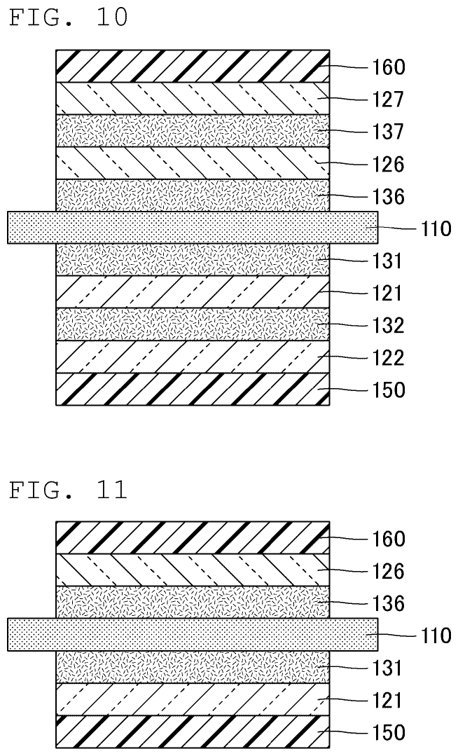

FIG. 9 is a cross-sectional view schematically showing the structure of a polarizer-including liquid crystal panel in a liquid crystal display device of Example 1. As shown in the figure, the liquid crystal display device of Example 1 included, in order from the backlight (omitted from the figure) side, the first polarizer 150, the acrylic film 124, a high-modulus bonding layer 134, the acrylic film 123, a high-modulus bonding layer 133, the acrylic film 122, a high-modulus bonding layer 132, the acrylic film 121, a high-modulus bonding layer 131, the liquid crystal panel 110, a high-modulus bonding layer 136, the acrylic film 126, a high-modulus bonding layer 137, the acrylic film 127, a high-modulus bonding layer 138, the acrylic film 128, a high-modulus bonding layer 139, the acrylic film 129, and the second polarizer 160. These layers and films were laminated and integrated.

In Example 1, the first polarizer 150, the liquid crystal panel 110, and the second polarizer 160 were the same as those described in Comparative Example 1. The liquid crystal panel 110 included a TFT substrate, a liquid crystal layer, and a color filter substrate. The TFT substrate included a glass substrate corresponding to the first substrate which exhibited birefringence in a direction parallel to the direction of stress. The liquid crystal layer contained a positive liquid crystal. The color filter substrate included a glass substrate corresponding to the second substrate which exhibited birefringence in a direction parallel to the direction of stress.

Four acrylic films were bonded to the observer side (second polarizer 160 side relative to the second substrate) of the liquid crystal panel 110 and four to the backlight side (first polarizer 150 side relative to the first substrate) of the liquid crystal panel 110, each via a high-modulus bonding layer. In other words, the liquid crystal display device of Example 1 included the laminate including four high-modulus bonding layers and four acrylic films on each of the observer side (second polarizer 160 side relative to the second substrate) of the liquid crystal panel 110 and the backlight side (first polarizer 150 side relative to the first substrate) of the liquid crystal panel 110. The acrylic films 121 to 124 and 126 to 129 were made of a polymethyl methacrylate resin (PMMA). The high-modulus bonding layers 131 to 134 and 136 to 139 were made of an acrylic adhesive and had a storage modulus at 25° C. of 0.11 MPa.

The acrylic films 121 to 124 and 126 to 129 had a negative photoelastic coefficient. The photoelastic coefficient β_{f}, the thickness d_{f}, and the number of films N_{f} on each of the observer side and the backlight side of the liquid crystal panel 110, and the product of the photoelastic coefficient β_{f}, the thickness d_{f}, and the number of films N_{f} were as shown below. The following value of β_{f}×d_{f}×NE represents the value of each of the total value on the observer side of the liquid crystal panel 110 and the total value on the backlight side of the liquid crystal panel 110.
Photoelastic coefficient β_{f}: −2.70E-13 (cm²/dyn)
Thickness d_{f}: 50 μm
Number of films N_{f}: 4

$${β}_{f} \times {d}_{f} \times {N}_{f} : - 5.4 E - 15 ( {cm}^{3} / dyn )$$

In Example 1, four acrylic films were laminated on each of the observer side and the backlight side of the liquid crystal panel 110, and the product β_{f}×d_{f}×N_{f} of the film photoelastic coefficient β_{f}, the film thickness d_{f}, and the number of films N_{f} was adjusted to be equal to the product β_{g}×d_{g} of the photoelastic coefficient β_{g} of the glass substrate and the thickness do of the glass substrate.

### (Results of Black Display Unevenness Assessment)

The same assessment method as in Comparative Example 1 was used to measure the in-plane luminance distribution of the cover glass-including liquid crystal panel of Example 1 in the black display state, and the maximum luminance and the minimum luminance were extracted, which were as shown below.

The black display unevenness index value was 60%, which was better than the value in Comparative Example 2 and greatly exceeded 30%, the target for improvement. Unevenness was not perceived.
Panel in-plane maximum luminance: 1.075 (cd/m²)
Panel in-plane minimum luminance: 0.645 (cd/m²)
Black display unevenness index value: 60%

In Example 1, the high-modulus bonding layers with a high storage modulus were used to bond the acrylic films, which seems to have caused application of stress, which was of the same magnitude as the stress applied to the liquid crystal panel (glass substrates), also to the acrylic films. Thus, in the acrylic films, a photoelasticity-induced phase difference of the same magnitude as that in the glass substrate was generated, with its slow axis perpendicular to the slow axis of the phase difference in the glass substrate. As a result, the phase difference in the glass substrate was offset by the phase difference in the acrylic films. This seems to be how the black display unevenness was significantly reduced.

### Example 2

FIG. 10 is a cross-sectional view schematically showing the structure of a polarizer-including liquid crystal panel in a liquid crystal display device of Example 2. As shown in the figure, the liquid crystal display device of Example 2 included, in order from the backlight (omitted from the figure) side, the first polarizer 150, the acrylic film 122, the high-modulus bonding layer 132, the acrylic film 121, the high-modulus bonding layer 131, the liquid crystal panel 110, the high-modulus bonding layer 136, the acrylic film 126, the high-modulus bonding layer 137, the acrylic film 127, and the second polarizer 160. These layers and films were laminated and integrated.

In Example 2, the first polarizer 150, the liquid crystal panel 110, and the second polarizer 160 were the same as those described in Comparative Example 1. Two acrylic films were bonded to the observer side of the liquid crystal panel 110 and two to the backlight side, each via a high-modulus bonding layer. The acrylic films 121, 122, 126, and 127 were made of a polymethyl methacrylate resin (PMMA). The high-modulus bonding layers 131, 132, 136, and 137 were made of an acrylic adhesive and had a storage modulus at 25° C. of 0.11 MPa.

The acrylic films 121, 122, 126, and 127 had a negative photoelastic coefficient. The photoelastic coefficient β_{f}, the thickness d_{f}, and the number of films N_{f} on each of the observer side and the backlight side of the liquid crystal panel 110, and the product of the photoelastic coefficient β_{f}, the thickness d_{f}, and the number of films N_{f} were as shown below. The following value of β_{f}×d_{f}×NE represents the value of each of the total value on the observer side of the liquid crystal panel 110 and the total value on the backlight side of the liquid crystal panel 110.
Photoelastic coefficient β_{f}: −2.70E-13 (cm²/dyn)
Thickness d_{f}: 50 μm
Number of films N_{f}: 2

$${β}_{f} \times {d}_{f} \times {N}_{f} : - 2.7 E - 15 ( {cm}^{3} / dyn )$$

In Example 2, two acrylic films were laminated on each of the observer side and the backlight side of the liquid crystal panel 110, and the product β_{f}×d_{f}×N_{f} of the film photoelastic coefficient β_{f}, the film thickness d_{f}, and the number of films N_{f} was adjusted to be half the product β_{g}×d_{g} of the photoelastic coefficient β_{g} of the glass substrate and the thickness d_{g} of the glass substrate.

### (Results of Black Display Unevenness Assessment)

The same assessment method as in Comparative Example 1 was used to measure the in-plane luminance distribution of the cover glass-including liquid crystal panel of Example 2 in the black display state, and the maximum luminance and the minimum luminance were extracted, which were as shown below.

The black display unevenness index value was 43%, which was smaller in effect than that in Example 1 in which four acrylic films were laminated on each side of the liquid crystal panel 110, but greatly exceeded 30%, the target for improvement. Unevenness was hardly perceived.
Panel in-plane maximum luminance: 1.431 (cd/m²)
Panel in-plane minimum luminance: 0.617 (cd/m²)
Black display unevenness index value: 43%

### Example 3

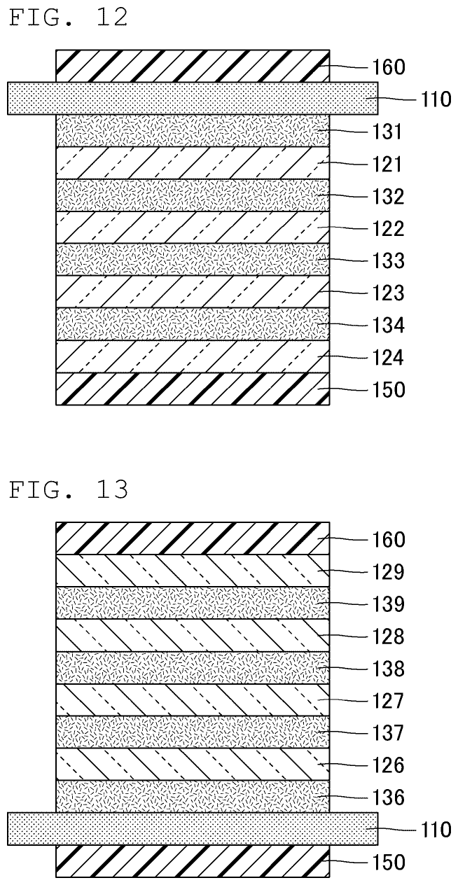

FIG. 11 is a cross-sectional view schematically showing the structure of a polarizer-including liquid crystal panel in a liquid crystal display device of Example 3. As shown in the figure, the liquid crystal display device of Example 3 included, in order from the backlight (omitted from the figure) side, the first polarizer 150, the acrylic film 121, the high-modulus bonding layer 131, the liquid crystal panel 110, the high-modulus bonding layer 136, the acrylic film 126, and the second polarizer 160. These layers and films were laminated and integrated.

In Example 3, the first polarizer 150, the liquid crystal panel 110, and the second polarizer 160 were the same as those described in Comparative Example 1. One acrylic film was bonded to the observer side of the liquid crystal panel 110 and one to the backlight side, each via a high-modulus bonding layer. The acrylic films 121 and 126 were made of a polymethyl methacrylate resin (PMMA). The high-modulus bonding layers 131 and 136 were made of an acrylic adhesive and had a storage modulus at 25° C. of 0.11 MPa.

The acrylic films 121 and 126 had a negative photoelastic coefficient. The photoelastic coefficient β_{f}, the thickness d_{f}, and the number of films N_{f} on each of the observer side and the backlight side of the liquid crystal panel 110, and the product of the photoelastic coefficient β_{f}, the thickness d_{f}, and the number of films N_{f} were as shown below. The following value of β_{f}×d_{f}×N_{f} represents the value of each of the total value on the observer side of the liquid crystal panel 110 and the total value on the backlight side of the liquid crystal panel 110.
Photoelastic coefficient β_{f}: −2.70E-13 (cm²/dyn)
Thickness d_{f}: 50 μm
Number of films N_{f}: 1

$${β}_{f} \times {d}_{f} \times {N}_{f} : - 1.35 E - 15 ( {cm}^{3} / dyn )$$

In Example 3, one acrylic film was laminated on each of the observer side and the backlight side of the liquid crystal panel 110, and the product β_{f}×d_{f}×NE of the film photoelastic coefficient β_{f}, the film thickness d_{f}, and the number of films N_{f} was adjusted to be ¼ of the product β_{g}×d_{g} of the photoelastic coefficient β_{g} of the glass substrate and the thickness do of the glass substrate.

### (Results of Black Display Unevenness Assessment)

The same assessment method as in Comparative Example 1 was used to measure the in-plane luminance distribution of the cover glass-including liquid crystal panel of Example 3 in the black display state, and the maximum luminance and the minimum luminance were extracted, which were as shown below.

The black display unevenness index value was 34%, which was even smaller in effect than that in Example 2 in which two acrylic films were laminated on each side of the liquid crystal panel 110, but greatly exceeded 30%, the target for improvement. Unevenness was hardly perceived.
Panel in-plane maximum luminance: 1.830 (cd/m²)
Panel in-plane minimum luminance: 0.625 (cd/m²)
Black display unevenness index value: 34%

### Example 4

FIG. 12 is a cross-sectional view schematically showing the structure of a polarizer-including liquid crystal panel in a liquid crystal display device of Example 4. As shown in the figure, the liquid crystal display device of Example 4 included, in order from the backlight (omitted from the figure) side, the first polarizer 150, the acrylic film 124, the high-modulus bonding layer 134, the acrylic film 123, the high-modulus bonding layer 133, the acrylic film 122, the high-modulus bonding layer 132, the acrylic film 121, the high-modulus bonding layer 131, the liquid crystal panel 110, and the second polarizer 160. These layers and films were laminated and integrated.

In Example 4, the first polarizer 150, the liquid crystal panel 110, and the second polarizer 160 were the same as those described in Comparative Example 1. Four acrylic films were bonded only to the backlight side of the liquid crystal panel 110, each via a high-modulus bonding layer. The acrylic films 121 to 124 were made of a polymethyl methacrylate resin (PMMA). The high-modulus bonding layers 131 to 134 were made of an acrylic adhesive and had a storage modulus at 25° C. of 0.11 MPa.

The acrylic films 121 to 124 had a negative photoelastic coefficient. The photoelastic coefficient β_{f}, the thickness d_{f}, and the number of films N_{f} on the backlight side of the liquid crystal panel 110, and the product of the photoelastic coefficient β_{f}, the thickness d_{f}, and the number of films N_{f} were as shown below. The following value of β_{f}×d_{f}×N_{f} represents the total value on the backlight side of the liquid crystal panel 110.
Photoelastic coefficient β_{f}: −2.70E-13 (cm²/dyn)
Thickness d_{f}: 50 μm
The number of films N_{f}: 4

$${β}_{f} \times {d}_{f} \times {N}_{f} : - 5.4 E - 15 ( {cm}^{3} / dyn )$$

In Example 4, four acrylic films were laminated only on the backlight side of the liquid crystal panel 110, and the product β_{f}×d_{f}×N_{f} of the film photoelastic coefficient BE, the film thickness d_{f}, and the number of films N_{f} was adjusted to be equal to the product β_{g}×d_{g} of the photoelastic coefficient β_{g} of the glass substrate and the thickness do of the glass substrate.

### (Results of Black Display Unevenness Assessment)

The same assessment method as in Comparative Example 1 was used to measure the in-plane luminance distribution of the cover glass-including liquid crystal panel of Example 4 in the black display state, and the maximum luminance and the minimum luminance were extracted, which were as shown below.

The black display unevenness index value was 51%, which was higher than that in Example 2 in which four acrylic films in total were used, and greatly exceeded 30%, the target for improvement. Unevenness was not perceived.
Panel in-plane maximum luminance: 1.194 (cd/m²)
Panel in-plane minimum luminance: 0.609 (cd/m²)
Black display unevenness index value: 51%

The results above are considered to have been caused by the following factors.

First, generally, the black display unevenness occurs through the following steps (1) to (6) when stress is applied to the liquid crystal panel.
(1) Stress is applied to liquid crystal panel
(2) In each of backlight side glass substrate and observer side glass substrate, photoelasticity-induced phase difference is generated due to stress application
(3) Light which was converted to ideal linearly polarized light upon passage through backlight side polarizer is converted to slightly elliptically polarized light by the photoelasticity-induced phase difference in backlight side glass substrate
(4) Light which was converted to elliptically polarized light enters liquid crystal layer, passes through liquid crystal layer, and is thus converted to elliptically polarized light with higher ellipticity (polarization disorder is intensified after passage through liquid crystal layer)
(5) Light after passage through liquid crystal layer is further converted to elliptically polarized light with still higher ellipticity by photoelasticity-induced phase difference in observer side glass substrate (this change in polarization is not as large as that resulting from passage through liquid crystal layer)
(6) Light which was converted to strongly elliptically polarized light ultimately partially fails to be absorbed by observer side polarizer, which causes light leakage during black display and is perceived as unevenness

In the principle above by which black display unevenness is caused, the steps (3) and (4) are dominant factors of the black display unevenness. Thus, once the photoelasticity-induced phase difference in the backlight side glass substrate is successfully reduced, the polarization disorder is not intensified due to passage of elliptically polarized light through the liquid crystal layer, so that the black display unevenness can be effectively reduced.

### Example 5

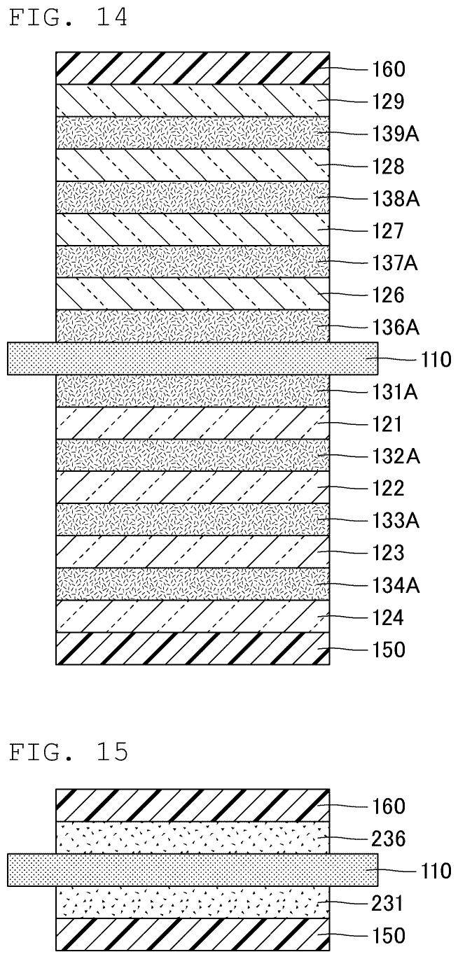

FIG. 13 is a cross-sectional view schematically showing the structure of a polarizer-including liquid crystal panel in a liquid crystal display device of Example 5. As shown in the figure, the liquid crystal display device of Example 5 included, in order from the backlight (omitted from the figure) side, the first polarizer 150, the liquid crystal panel 110, the high-modulus bonding layer 136, the acrylic film 126, the high-modulus bonding layer 137, the acrylic film 127, the high-modulus bonding layer 138, the acrylic film 128, the high-modulus bonding layer 139, the acrylic film 129, and the second polarizer 160. These layers and films were laminated and integrated.

In Example 5, the first polarizer 150, the liquid crystal panel 110, and the second polarizer 160 were the same as those described in Comparative Example 1. Four acrylic films were bonded only to the observer side of the liquid crystal panel 110, each via a high-modulus bonding layer. The acrylic films 126 to 129 were made of a polymethyl methacrylate resin (PMMA). The high-modulus bonding layers 136 to 139 were made of an acrylic adhesive and had a storage modulus at 25° C. of 0.11 MPa.

The acrylic films 126 to 129 had a negative photoelastic coefficient. The photoelastic coefficient β_{f}, the thickness d_{f}, and the number of films N_{f} on the observer side of the liquid crystal panel 110, and the product of the photoelastic coefficient β_{f}, the thickness d_{f}, and the number of films N_{f} were as shown below. The following value of β_{f}×d_{f}×NE represents the total value on the observer side of the liquid crystal panel 110.
Photoelastic coefficient β_{f}: −2.70E-13 (cm²/dyn)
Thickness d_{f}: 50 μm
Number of films N_{f}: 4

$${β}_{f} \times {d}_{f} \times {N}_{f} : - 5.4 E - 15 ( {cm}^{3} / dyn )$$

In Example 5, four acrylic films were laminated only on the observer side of the liquid crystal panel 110, and the product β_{f}×d_{f}×N_{f} of the film photoelastic coefficient β_{f}, the film thickness d_{f}, and the number of films N_{f} was adjusted to be equal to the product β_{g}×d_{g} of the photoelastic coefficient β_{g} of the glass substrate and the thickness do of the glass substrate.

### (Results of Black Display Unevenness Assessment)

The same assessment method as in Comparative Example 1 was used to measure the in-plane luminance distribution of the cover glass-including liquid crystal panel of Example 5 in the black display state, and the maximum luminance and the minimum luminance were extracted, which were as shown below.

The black display unevenness index value was 37%, which was lower than that in Example 2 with two acrylic films laminated on each side of the liquid crystal panel 110 or that in Example 4 with four acrylic films laminated on the backlight side, but exceeded 30%, the target for improvement. Unevenness was hardly perceived.
Panel in-plane maximum luminance: 1.732 (cd/m²)
Panel in-plane minimum luminance: 0.641 (cd/m²)
Black display unevenness index value: 37%

### Example 6

FIG. 14 is a cross-sectional view schematically showing the structure of a polarizer-including liquid crystal panel in a liquid crystal display device of Example 6. As shown in the figure, the liquid crystal display device of Example 6 included, in order from the backlight (omitted from the figure) side, the first polarizer 150, the acrylic film 124, a high-modulus bonding layer 134A, the acrylic film 123, a high-modulus bonding layer 133A, the acrylic film 122, a high-modulus bonding layer 132A, the acrylic film 121, a high-modulus bonding layer 131A, the liquid crystal panel 110, a high-modulus bonding layer 136A, the acrylic film 126, a high-modulus bonding layer 137A, the acrylic film 127, a high-modulus bonding layer 138A, the acrylic film 128, a high-modulus bonding layer 139A, the acrylic film 129, and the second polarizer 160. These layers and films were laminated and integrated.

In Example 6, the first polarizer 150, the liquid crystal panel 110, and the second polarizer 160 were the same as those described in Comparative Example 1. Four acrylic films were bonded to the observer side of the liquid crystal panel 110 and four to the backlight side, each via a high-modulus bonding layer. The acrylic films 121 to 124 and 126 to 129 were made of a polymethyl methacrylate resin (PMMA). The high-modulus bonding layers 131A to 134A and 136A to 139A were made of an acrylic adhesive and had a storage modulus at 25° C. of 0.13 MPa.

The acrylic films 121 to 124 and 126 to 129 had a negative photoelastic coefficient. The photoelastic coefficient β_{f}, the thickness d_{f}, and the number of films N_{f} on each of the observer side and the backlight side of the liquid crystal panel 110, and the product of the photoelastic coefficient β_{f}, the thickness d_{f}, and the number of films NE were as shown below.
Photoelastic coefficient BE: −2.70E-13 (cm²/dyn)
Thickness d_{f}: 50 μm
Number of films N_{f}: 4

$${β}_{f} \times {d}_{f} \times {N}_{f} : - 5.4 E - 15 ( {cm}^{3} / dyn )$$

In Example 6, four acrylic films were laminated on each of the observer side and the backlight side of the liquid crystal panel 110, and the product β_{f}×d_{f}×N_{f} of the film photoelastic coefficient β_{f}, the film thickness d_{f}, and the number of films N_{f} was adjusted to be equal to the product β_{g}×d_{g} of the photoelastic coefficient β_{g} of the glass substrate and the thickness d_{g} of the glass substrate.

### (Results of Black Display Unevenness Assessment)

The same assessment method as in Comparative Example 1 was used to measure the in-plane luminance distribution of the cover glass-including liquid crystal panel of Example 6 in the black display state, and the maximum luminance and the minimum luminance were extracted, which were as shown below.

The black display unevenness index value was 66%, which greatly exceeded 30%, the target for improvement. Unevenness was not perceived.
Panel in-plane maximum luminance: 0.973 (cd/m²)
Panel in-plane minimum luminance: 0.638 (cd/m²)
Black display unevenness index value: 66%

In Example 6, the high-modulus bonding layers with a high storage modulus were used to bond the acrylic films, which seems to have caused application of stress, which is of the same magnitude as the stress applied to the liquid crystal panel (glass substrates), also to the acrylic films. Thus, in the acrylic films, a photoelasticity-induced phase difference of the same magnitude as that in the glass substrate was generated, with its slow axis perpendicular to the slow axis of the phase difference in the glass substrate. As a result, the phase difference in the glass substrate was offset by the phase difference in the acrylic films. This seems to be how the black display unevenness was significantly reduced.

### REFERENCE SIGNS LIST

10: measurement sample
11: force gauge
12A: light emitter
12B: light detector
80: backlight
100: polarizer-including liquid crystal panel
110: liquid crystal panel
112: color filter substrate
113: second glass substrate
114: liquid crystal layer
116: TFT substrate
117: first glass substrate
120: negative photoelastic film
121, 122, 123, 124, 126, 127, 128, 129: acrylic film
130, 131, 131A, 132, 132A, 133, 133A, 134, 134A, 136, 136A,
137, 137A, 138, 138A, 139, 139A: high-modulus bonding layer
150: first polarizer
160: second polarizer
231, 232, 233, 234, 236, 237, 238, 239: adhesive layer
310: liquid crystal panel before polarizer bonding
320: liquid crystal panel after polarizer bonding
330: forcibly flattened liquid crystal panel
350: cover glass
380: liquid crystal panel after cover glass bonding
400: polarizer-including liquid crystal panel

What is claimed is:

1. A liquid crystal display device comprising, in order:
a backlight;
a first polarizer;
a first substrate which exhibits birefringence in a direction parallel to a direction of stress;
a liquid crystal layer;
a second substrate which exhibits birefringence in a direction parallel to a direction of stress; and
a second polarizer,
the liquid crystal display device comprising, on at least one of a first polarizer side relative to the first substrate or a second polarizer side relative to the second substrate, at least one laminate of a bonding layer with a storage modulus at 25° C. of 0.10 MPa or more and a film that exhibits birefringence in a direction vertical to a direction of stress,
wherein a sum of absolute values of products of a photoelastic constant and thickness of the film in the at least one laminate is approximately equal to an absolute value of a product of a photoelastic constant and thickness of the first substrate or the second substrate, whichever is adjacent to the at least one laminate.

2. The liquid crystal display device according to claim 1,
wherein the at least one laminate, on at least one of the first polarizer side relative to the first substrate or the second polarizer side relative to the second substrate, comprises a plurality of laminates.

3. The liquid crystal display device according to claim 1,
wherein the at least one laminate is on both the first polarizer side relative to the first substrate and the second polarizer side relative to the second substrate.

4. The liquid crystal display device according to claim 1,
wherein the at least one laminate is only on the first polarizer side relative to the first substrate.

5. The liquid crystal display device according to claim 1,
wherein the at least one laminate is only on the second polarizer side relative to the second substrate.

6. The liquid crystal display device according to claim 1,
wherein the film comprises a polymethyl methacrylate resin.

7. The liquid crystal display device according to claim 2,
wherein the number of the plurality of laminates on the first polarizer side relative to the first substrate is 4 or more.

8. The liquid crystal display device according to claim 3,
wherein the number of the at least one laminate on the first polarizer side relative to the first substrate is larger than the number of the at least one laminate on the second polarizer side relative to the second substrate.
